(19) United States
(12) Patent Application Publication
(10) Pub. No.: US 2012/0047696 A1
(43) Pub. Date: Mar. 1, 2012

(54) CLAMP FOR BOARD CLAMPING

(75) Inventors: Byung Wul JUNG, Busan (KR); Seung Yeop KOOK, Busan (KR); Ho Myung KANG, Busan (KR); Yeong Rak SONG, Gyeongsangnam-do (KR)

(73) Assignee: SAMSUNG ELECTRO-MECHANICS CO., LTD., Gyunggi-do (KR)

(21) Appl. No.: 13/223,208

(22) Filed: Aug. 31, 2011

(30) Foreign Application Priority Data
Sep. 1, 2010 (KR) 10-2010-0085549

(51) Int. Cl. F16B 2/06

(52) U.S. Cl. 24/457

(57) ABSTRACT

Disclosed herein is a clamp for board clamping in which a board clamping part for clamping a board at the time of processing and testing of the board and a base are formed to have different colors to easily recognize an abrasion degree of the board clamping part without measurement by a mechanical device such as a measuring instrument, thereby determining a replacement cycle of the clamp.

### CROSS REFERENCE TO RELATED APPLICATION

This application claims the benefit of Korean Patent Application No. 10-2010-0085549, filed on Sep. 1, 2010, entitled “Clamp For Board Clamping” which is hereby incorporated by reference in its entirety into this application.

### BACKGROUND OF THE INVENTION

1. Technical Field

The present invention relates to a clamp for board clamping.

2. Description of the Related Art

In a process of manufacturing a board, processing or testing on the board has been inevitably performed. Particularly, it is very important to accurately determine whether or not a function is normal through testing performed before the board is shipped.

The processing or testing on the board is performed at a time with the entire net using a jig generally called a fixture as an example or is partially performed using a probe as another example.

Here, in the case of performing the process or testing on the board using the jig, a device called a work holder including a clamp is required in order to clamp the board. That is, the work holder includes a holder serving as the entire frame, a plate supporting the board, and the clamp catching and clamping the board.

Korean Patent Publication No. 2005-0091356A relates to a testing device including the clamp. As described on pages 6 and 7 of the description and shown in FIG. 5 of Korean Patent Publication No. 2005-0091356A, the testing on the board has been performed in a state in which each edge of the board is caught and clamped through vertical rotation of the clamp.

In addition, Korean Patent Publication No. 2009-0109871A relates to a processing device including the clamp. As described on pages 5 and 6 of the description and shown in FIG. 5B of Korean Patent Publication No. 2009-0109871A, the processing has been performed in a state in which a side of a loaded board is supported and clamped by driving a clamp installed on a work table.

However, the clamp disclosed in the existing patent documents including the above-mentioned Korean Patent Publication No. 2005-0091356A and Korean Patent Publication No. 2009-0109871A has considered only a function for clamping a board but has not considered replacement of the clamp inevitably generated in using the clamp at all. Therefore, temporal and spatial loss has been generated in a process of processing or testing the board.

That is, since the clamp needs to repeatedly and continuously support and clamp the board, physical abrasion has been generated at a contact part between the clamp and the board. When this phenomenon is left as it is, problems that the clamp may not clamp the board or the board is separated, warped, or twisted during a process of processing or testing the board. Therefore, it is recommended that the clamp having the abrasion generated in a contact part clamping the board is replaced on the spot.

Determination of whether or not the clamp is replaced has been performed by a measuring instrument. However, in the case in which an abrasion degree for individual clamps is measured by the measuring instrument and whether or not the clamp is replaced is determined based on the measurement, the measuring instrument is separately installed and operated during the process of processing or testing the board, such that spatial loss as well as temporal loss is generated.

### SUMMARY OF THE INVENTION

Therefore, the present invention is proposed to solve problems generated because a replacement cycle of a clamp is determined through measurement of an abrasion degree by a separate mechanical device such as a measuring instrument.

The present invention has been made in an effort to provide a clamp for board clamping of which a replacement cycle may be recognized without measurement.

According to a preferred embodiment of the present invention, there is provided a clamp for board clamping disposed on a structure to thereby clamp a board, the clamp including: a base installed on the structure; and a board clamping part formed on the base and contacting the board, wherein the board clamping part is formed to have a color different from that of the base.

The board clamping part may have dye coated on a surface thereof.

Each of the board clamping part and the base may be made of resins mixed with dyes having different colors.

Each of the board clamping part and the base may be formed by injecting or casting epoxy resins having different colors.

### BRIEF DESCRIPTION OF THE DRAWINGS

FIG. 1 is a perspective view showing a clamp according to a preferred embodiment of the present invention;

FIG. 2 is a cross-sectional view showing an example in which a board is clamped by a clamp according to a preferred embodiment of the present invention; and

FIG. 3 is a perspective view showing an abrasion degree of a board clamping part according to a preferred embodiment of the present invention.

### DESCRIPTION OF THE PREFERRED EMBODIMENTS

Hereinafter, a preferred embodiment of the present invention is described hereafter in detail with reference to the accompanying drawings.

A clamp 10 according to a preferred embodiment of the present invention includes a base 11 installed on a structure 2 disposed at a board manufacturing process line and a board clamping part 12 clamping a board 1, wherein the base 11 and the board clamping part 12 are formed to have different colors so that a boundary 12a therebetween is discriminated.

Here, the structure 2 on which the clamp 10 is disposed is a work holder including a holder 3 and a plate 4 for supporting the board as an example. Hereinafter, a description will be provided based on a case in which the structure 2 is the work holder.

However, the case in which the structure 2 is the work holder is only an example. Since the clamp 10 may be generally used in a board manufacturing process, the structure 2 is not necessarily limited to being the work holder.

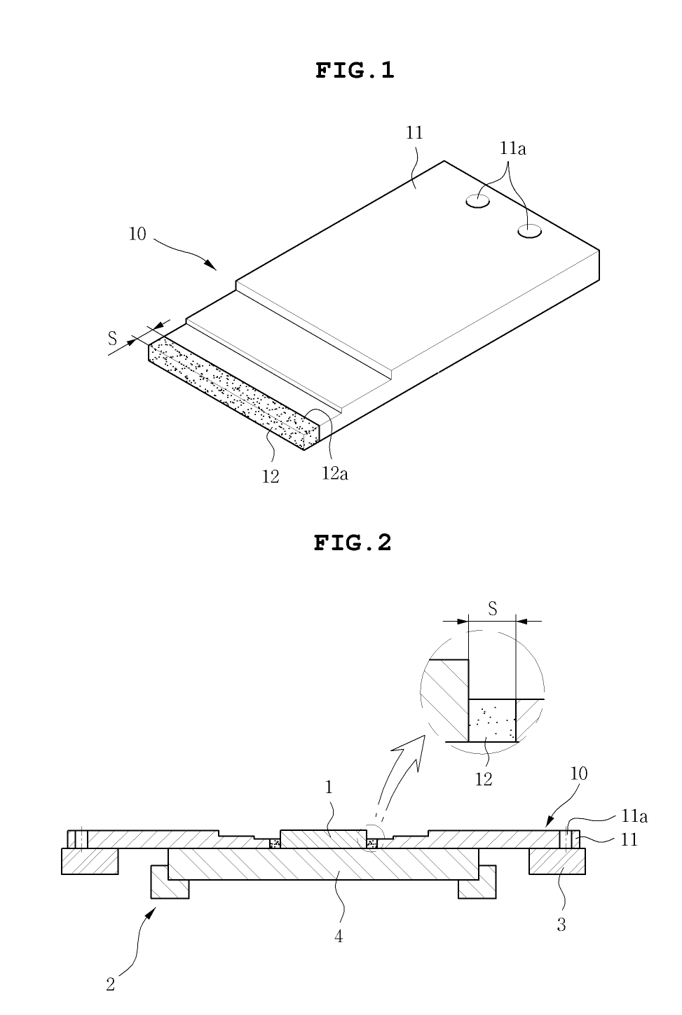

Meanwhile, the clamp 10 according to the preferred embodiment of the present invention includes the base 11 as described above. The base 11, which is a part corresponding to a rear part of the clamp 10 based on FIG. 1, is installed on an upper part of the structure 2, for example, an upper surface of the holder 3 to thereby allow the clamp 10 not to move.

The base 11 is installed through a coupling hole 11a formed to have a hole shape, and the clamp 10 is installed by coupling a bolt into the coupling hole 11a and bolting the bolt into the holder 3.

The board clamping part 12, which is a part corresponding to a front part of the clamp 10 based on FIG. 1, substantially clamps the board 1 and has an upper surface stepped in a step shape in consideration of connectivity with a jig generally called a fixture.

A lower portion of the board 1 of which sides are clamped by the board clamping part 12 is supported by the plate 4. That is, as shown in FIG. 2, the plate 4 supports the lower portion of the board 1 in a state in which the board clamping part 12 is closely adhered to the sides of the board 1, thereby making it possible to easily perform processing and testing on the board 1.

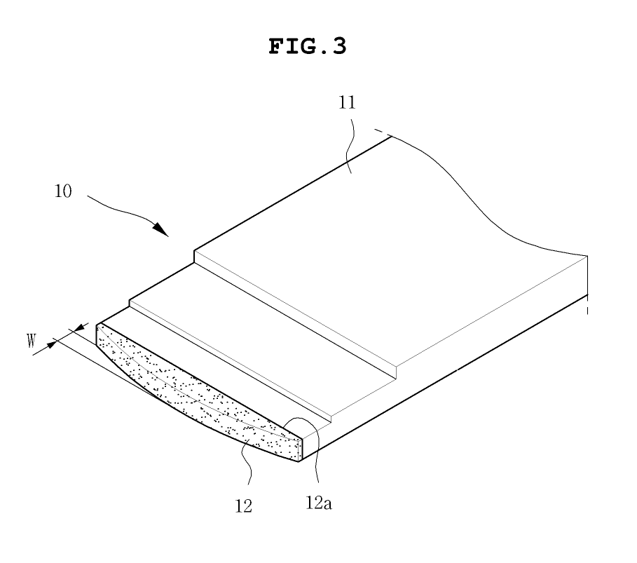

Meanwhile, the board clamping part 12 according to the preferred embodiment of the present invention is supplied to the spot in a state in which it is formed to have a color different from that of the base 11. Therefore, as shown in FIG. 3, an abrasion degree W generated during a process of clamping the board 1 may be recognized.

Here, a method for forming the board clamping part 12 so as to have a color different from that of the base 11 will be described below. First, a case in which dye is coated on a surface of the board clamping part 12 will be described as an example.

That is, dye having a color different from that of the base 11 is coated on the surface of the board clamping part 12 to discriminate a boundary 12a between the board clamping part 12 and the base 11, such that an abrasion degree W with respect to a size S of the board clamping part 12 is recognized, thereby determining a replacement cycle of the clamp 10.

More preferably, when the base has a yellow color, dye having a color contrasted with the yellow color, for example, a red color, is repeatedly coated on the surface of the board clamping pat 12 to allow the boundary 12a to be clearly discriminated, thereby making it possible to easily the abrasion degree W.

As another example, dyes having different colors are mixed with each other during a process of manufacturing the board clamping part 12 and the base 11. Here, the board clamping part 12 and the base 11 may be formed individually from each other or integrally with each other. A detailed description thereof will be provided below.

For example, when the base 11 is made of an epoxy resin mixed with dye having a yellow color and the board clamping part 12 is made of an epoxy resin mixed with dye having a red color, the finally manufactured clamp 10 includes a yellow base 11 and a red board clamping part 12.

The above-mentioned scheme is appropriate for mass production since the clamp 10 may be formed through injection or casting. Particularly, even though the board clamping part 12 repeatedly clamps the board 1 for a long time, the above-mentioned scheme may prevent deterioration of discrimination due to discoloration or peeling of the color.

Hereinafter, a process of clamping the board 1 through the clamp 10 according to the preferred embodiment of the present invention will be described in detail. The clamp 10 is first installed on the holder 3 using the base 11.

Then, the board 1 for processing or testing is clamped through the board clamping part 12. The board clamping part 12 surface-contacts the sides of the board 1 during a process of clamping the board 1, such that the board 1 is clamped.

Meanwhile, the board 1 after the processing or the electrical testing is finished is separated from the board clamping part 12, is transferred to a subsequent process, and a new board 1 is then supplied and clamped to the board clamping part 12.

Here, when the board clamping part 12 is viewed before the new board 1 is clamped, in the case in which the abrasion degree W with respect to the size S is excessive as shown in HG. 3, the clamp 10 is separated from the holder 3 and a new clamp 10 is then installed to thereby clamp the board 1.

Therefore, a replacement cycle of the clamp 10 may be easily determined, thereby making it possible to secure workability and stability in processing or testing the board 1.

As set forth above, according to the preferred embodiment of the present invention, the board clamping part and the base are formed to have different colors so that a boundary therebetween is discriminated, such that the abrasion degree due to physical impact between the clamp and the board is easily recognized, thereby making it possible to determine the replacement cycle of the clamp.

Meanwhile, the board clamping part and the base are formed to have different colors in a scheme of coating the dye, such that a boundary therebetween may be clearly discriminated and repetitive coating may be performed, thereby making it possible to prevent deterioration of the discrimination.

Meanwhile, the boundary between the base the board clamping part is discriminated by mixing the dyes having different colors with the resins, thereby making it possible to prevent deterioration of the discrimination due to peeling, or the like, caused by physical impact. Particularly, the scheme of injecting or casting the epoxy resins having different colors is very appropriate for mass production, thereby making it possible to rapidly solve problems associated with reliability of the clamp.

Although the embodiments of the present invention regarding the clamp for board clamping have been disclosed for illustrative purposes, those skilled in the art will appreciate that a variety of different modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A clamp for board clamping disposed on a structure to thereby clamp a board, the clamp comprising:
a base installed on the structure; and
a board clamping part formed on the base and contacting the board,
wherein the board clamping part is formed to have a color different from that of the base.

2. The clamp as set forth in claim 1, wherein the board clamping part has dye coated on a surface thereof.

3. The clamp as set forth in claim 1, wherein each of the board clamping part and the base is made of resins mixed with dyes having different colors.

4. The clamp as set forth in claim 3, wherein each of the board clamping part and the base are formed by injecting or casting epoxy resins having different colors.
